(19) United States
(12) Patent Application Publication
(10) Pub. No.: US 2007/0236954 A1
(43) Pub. Date: Oct. 11, 2007

(54) Mounting arrangement for isolating automotive components from vibration

(76) Inventor: Leo F. Schwab, Fraser, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/398,927

(22) Filed: Apr. 6, 2006

(51) Int. Cl. F21V 7/04

(52) U.S. Cl. 362/549

(57) ABSTRACT

A mounting arrangement for mounting a headlamp housing or other automotive vehicle component to frame structure, such as a bumper. The headlamp housing is attached by an array of unitary beams comprising a column portion and a fork-shaped portion. The fork-shaped portion has a base extending in opposite directions of and transversely with respect to the column portion and a pair of arms that are unitary with the base and extend transversely with respect to both the base and the column portion. The arms have ends joined to a housing of the headlamp either by being unitary therewith or by being fastened thereto with separate fasteners. The unitary beams are simple beams that may be dimensionally modified in order to tune their response to a selected level, such as for example, a first natural frequency of about 45 Hz, which is a frequency suitable for headlamps. Preferably, the beams are made of polypropylene reinforced with talc.

### FIELD OF THE INVENTION

The present invention relates to mounting arrangements for isolating automotive components from vibration. More particularly, the present invention relates to mounting arrangements for isolating automotive components from vibration wherein the automotive components are items, such as, but not limited to, headlamp housings with headlamps therein.

### BACKGROUND OF THE INVENTION

Automotive components, such as electrical devices, fragile mechanisms and lamp devices, frequently require isolation from vibration. Exemplary of such devices are vehicle headlamps which are normally mounted to the body of a vehicle. Headlamps are more fragile than other lamps in the vehicle in that they include many more internal parts such as brackets, reflectors, bulbs, internal adjuster mechanisms, and in some cases a projector lamp. Currently, headlamps are mounted directly to the body of a vehicle; however, mounting headlamps directly on vehicle frames or on bumpers is under consideration because it may be desirable to install headlamps at a lower height. This raises a concern because acceleration levels from road impacts into the frames of automotive vehicles are higher than acceleration levels into bodies mounted on frames.

A standard practice is to attach or support items such as headlamp housings with expensive rubber isolators that need adequate stiffness while simultaneously isolating damaging vibration loads. Such isolators use variables such as geometry, durometer and internal coring to produce correct stiffness in XYZ directions. This results in high costs and high dimensional variability. Current vehicles have very small gap and flush requirements and hence it is difficult to use elastomeric isolators to accurately locate a lamp housing to external surfaces of the vehicles. Exemplary of such surfaces are the surfaces of bumpers which are attached directly to the vehicle frames. When attaching a headlamp housing to a frame, it is necessary to have a minimal stiffness of about 45 Hz to prevent perceived visual flutter of the light beam, yet stiffness above about 45 Hz can transmit damaging impacts to the headlamp components.

In view of the aforementioned considerations, there is a need for an arrangement to mount components, such as vehicular headlamp housing, directly to a vehicle frame, rather than to the body of the vehicle.

### SUMMARY OF THE INVENTION

A mounting arrangement for mounting a support structure for an automotive component on an automotive vehicle comprises at least one unitary beam. The unitary beam has a column portion with a coupling component thereon for attaching the unitary beam to the automotive vehicle. A fork-shaped portion of the unitary beam extends from the column portion and has a base extending in opposite directions of, and transversely with respect to, the column portion. At least a pair of arms are unitary with the base and extend transversely with respect to both the base and the column portion, the arms each having ends joined to the supporting structure of the automotive component.

In still a further aspect, the column portion has a front and a rear surface and the coupling component comprises a screw received through a hole in the column portion, which screw is threaded into a nut adjacent to the rear surface of the column portion.

In still a further aspect, the nut is a J-nut having a threaded opening adjacent to the rear surface of the column portion for receiving the screw.

In still a further aspect, a locating pin projects from the column portion in a direction away from the arms.

In still a further aspect, the arms are integrally molded with the supporting structure.

In another embodiment, the arms are separate from the supporting structure and are coupled thereto by fasteners.

In a further aspect, the supporting structure is an automotive headlamp housing.

In a further aspect, the mounting arrangement is for an automotive headlamp housing mounted by an array of four unitary beams with a pair of the unitary beams joined to opposite sides of the housing.

In still a further aspect, the beams are tuned beams tuned to provide a minimum natural frequency in a range of about 30 to 60 Hz, and preferably about 45 Hz.

In still a further aspect, the headlamp housing is mounted by the pairs of unitary beams to proximate portions of a bumper which comprises the automotive structure.

In still further aspects, the unitary beams each have a locating pin projecting from the front surfaces of the column portions for engagement with the bumper portion, the couplings between the columns and the bumper portion being screws passing through holes in the bumper portion.

In still a further aspect, the automotive headlamp housing and unitary beams are made of a polymer material, which is preferably 30% talc filled polypropylene.

In still further aspects, the unitary beams are unitary with the automotive headlamp housing, and alternatively the unitary beams are separate from the automotive headlamp housing and are attached thereto by fasteners.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a top view, partially in elevation, of an automotive component such as a headlamp, supported on an automotive vehicle utilizing a mounting arrangement in accordance with the present invention;

FIG. 2 is a front perspective view of the automotive component of FIG. 1;

FIG. 3 is an exploded perspective view showing elements of the mounting arrangement prior to assembly;

FIG. 4 is a perspective view of one of four similar unitary beams, each of which is unitary with a headlamp housing; and

FIG. 5 is a second embodiment of the invention wherein the unitary beams are a separate components that are fastened to the headlamp housing.

### DETAILED DESCRIPTION

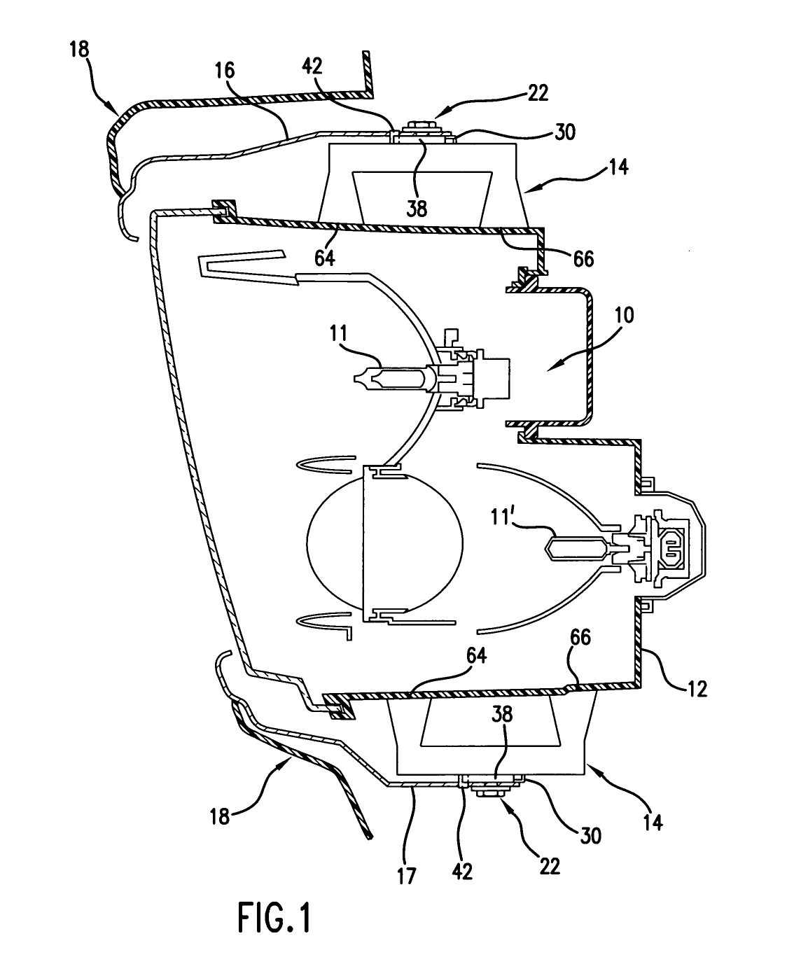

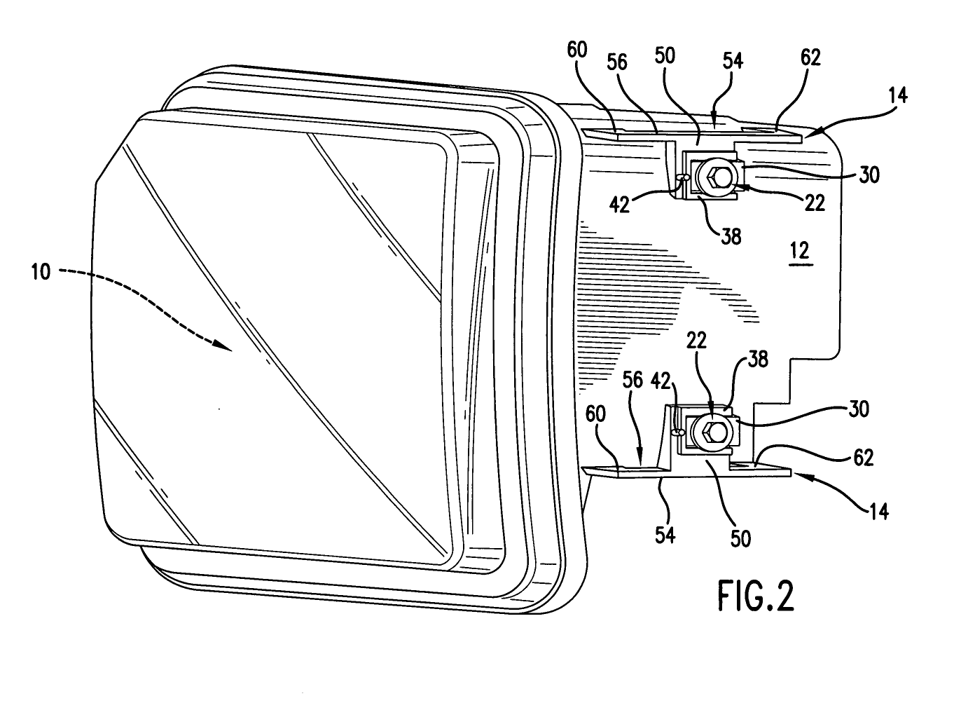

Referring now to FIGS. 1 and 2, an automotive component, such as a vehicle headlamp 10, is mounted in a housing 12 that is attached by an array of unitary beams 14 to portions 16 and 17 of vehicle bumper assembly 18. The vehicle headlamp 10 may include more than one bulb, such as the bulbs 11 and 11′, may utilize a single bulb or may be configured of LEDs. The vehicle bumper assembly 18 is fixedly attached to a frame (not shown) of an automotive vehicle (not shown) with the result that load impacts and other vibrations normally delivered to the vehicle frame are transmitted to the housing 12. In order to avoid damage to the headlamp 10 and to keep the headlamp from shaking and appearing to flicker, the housing 12 is damped by the array of unitary beams 14.

Unitary beams 14 are each similar in configuration, and as is apparent from the views of FIGS. 1 and 2, there are four independent beams, with one pair of unitary top beams 14 and one pair of unitary bottom beams 14. Preferably, the four unitary beams 14 are each molded of the same material as the housing 12 and are unitary with the housing. A preferred material is a polymer material, such as polypropylene filled about 30% talc filled.

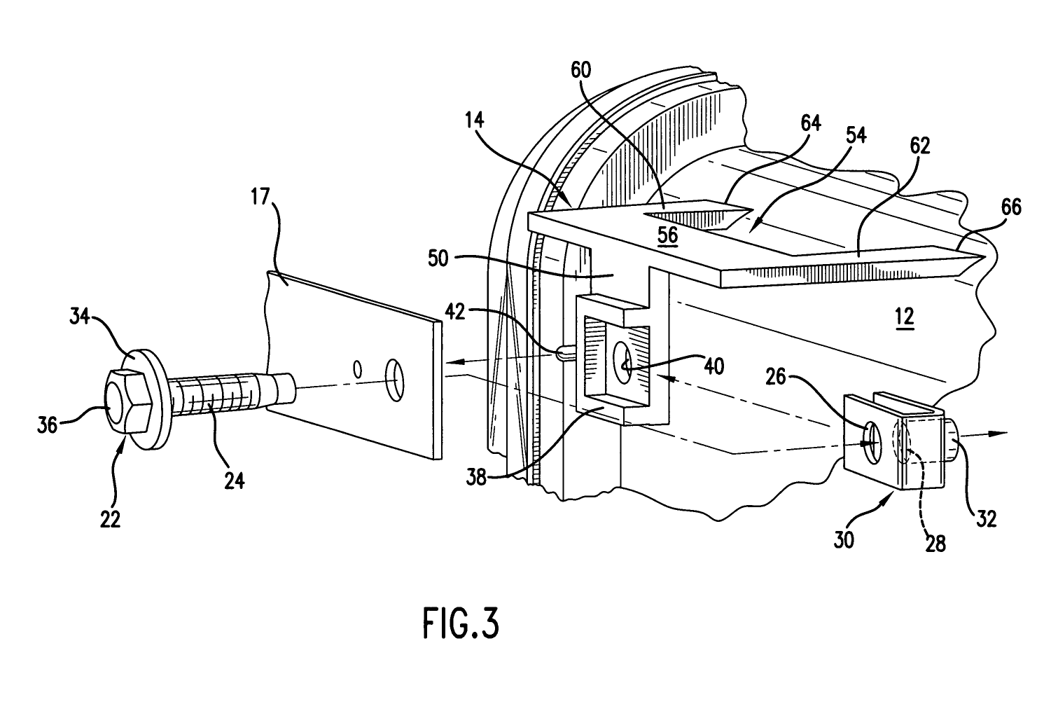

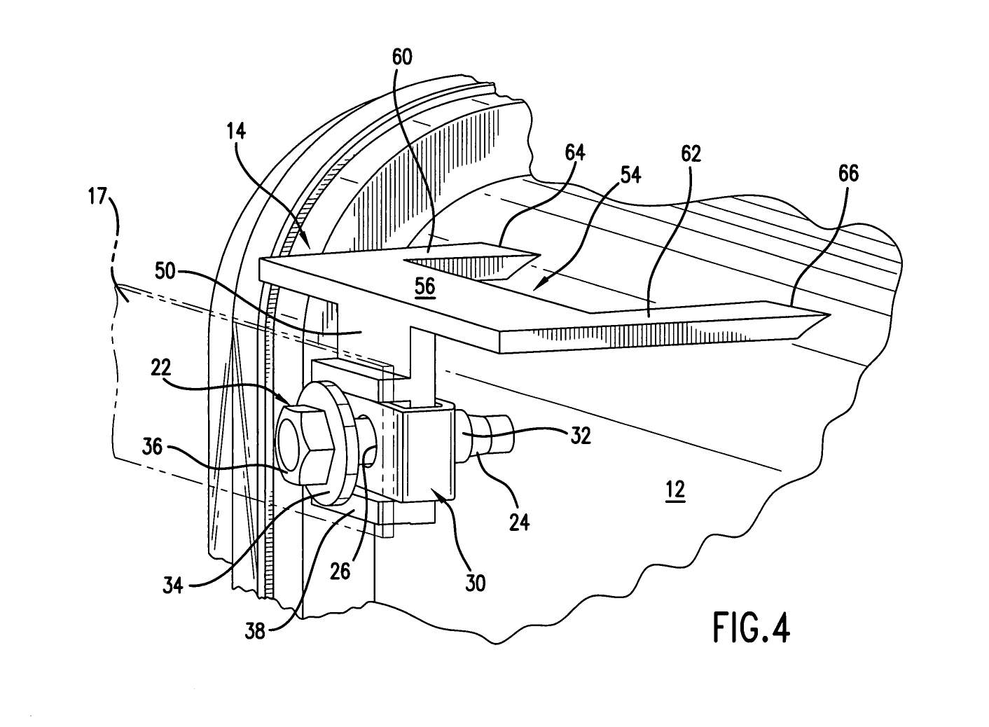

In FIGS. 3 and 4, a single unitary beam 14 is shown prior to and after attachment to the bumper portion 17, attachment to the bumper portion 16 being similarly performed. Each of the unitary beams 14 is attached to the respective bumper portion 16 or 17 by a cap screw 22 having a shank 24 that passes through a pair of aligned holes 26 and 28 in a J-nut 30. The J-nut 30 has a threaded portion 32 which is aligned with the holes 26 and 28. A flange 34 is integral with the hex nut head 36 of the cap screw 22 and bears against the outer surface of the bumper portion 16 or 17 (FIG. 1) on which the unitary beam 14 is mounted. U-shaped framing 38 is formed on the outer surface of each unitary beam 14 to receive the J-nut 30 while a hole 40 (FIG. 3) through the unitary beam 14 receives the shank 24 of the cap bolt 22. A locating pin 42 projects from each unitary beam 14 for receipt in a hole in the beam portions 16 or 17 (see FIG. 2).

As is seen in FIG. 4 in combination with FIGS. 1-3, each unitary beam 14 includes a column portion 50 that is coupled by the cap screw 22 to the bumper portions 16 and 17 (see FIGS. 1 and 2). The J-nut 30 slides over the column portion 50 of the unitary beam 14 so that the holes 26 and 28 in the J-nut align with the hole 40 (FIG. 3) through the column portion 50, while the U-shaped frame 38 properly positions the J-nut 30 with respect to the column portion 50. As is best seen in FIG. 1, the locating pin 42 on each of the column portions 50 of the unitary beams 14 facilitates mounting the housing 12 on the bumper portions 16 and 17 by being received in holes through the bumper portions. Upon tightening each cap screw 22, the housing 24 is firmly anchored to the bumper portions 16 and 17 of the bumper assembly 18 and thus to the frame of the vehicle.

Unitary with the column portion 50 of each of the unitary beams 14 is a fork-shaped portion 54 which is generally U-shaped in that it has a base 56 which extends in opposite directions transversely with respect to the column portion 50. First and second arms 60 and 62 extend in spaced relation laterally from end portions of the base 56 to the headlamp housing 12. The column portion 50, base portion 56 and arm portions 60 and 62 are simple beams molded from plastic that provide vertical and fore-aft flexibility for the headlamp housing 12 and thus the headlamp 10 therein. The geometry of the unitary beam 14 comprised of the simple beams 50, 56, 60 and 62 is adjusted to tune the supported lamp 10 and housing 12 to a first natural frequency in a range of 30-60 Hz with a preferably frequency of about 45 Hz. Preferably, the arms 60 and 62 are wider at the ends 64 and 66 where they join the housing 12, then where the arms join the base portion 56.

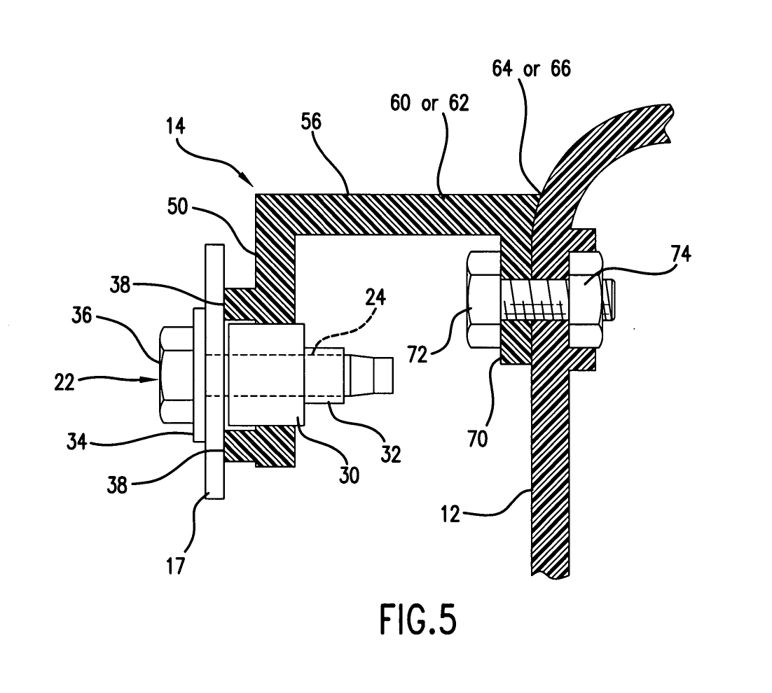

Referring now to FIG. 5, there is shown a second embodiment of the invention wherein the ends 64 or 66 of the arms 60 and 62 have tabs 70 thereon which have openings therethrough that receive cap screws 72. The cap screws 72 are threaded into nuts 74 inside of the housing 12 so as to provide fasteners for rigidly attaching the housing to the unitary beam 14.

While the unitary beams 14 are in the illustrated embodiment used to support headlamp housing 12, the unitary beams are also of use in supporting other vehicular components.

From the foregoing description, one skilled in the art can easily ascertain the essential characteristics of this invention, and without departing form the spirit and scope thereof, can make various changes and modifications of the invention to adapt it to various usages and conditions.

We claim:

1. A mounting arrangement for mounting a support structure for an automotive component on an automotive vehicle, the arrangement comprising:
at least one unitary beam comprised of:
a column portion having a coupling component thereon for attaching the unitary beam to the automotive vehicle, and
a fork-shaped portion having a base extending in opposite directions of and transversely with respect to the column portion, and having at least a pair of arms unitary with the base and extending transversely with respect to both the base and the column portion, the arms having ends joined to the supporting structure for the automotive component.

2. The mounting arrangement of claim 1 wherein the column portion has a front and rear surface and wherein the coupling component comprises a screw received through a hole in the column portion and threaded into a nut adjacent to the rear surface.

3. The mounting arrangement of claim 2 wherein the nut is a J-nut having a threaded opening adjacent to the rear surface of the column portion for receiving the screw.

4. The mounting arrangement of claim 3 wherein the screw has a head with an integral washer.

5. The mounting arrangement of claim 4 wherein a locating pin projects from the column portion in a direction away from the at least pair of arms.

6. The mounting arrangement of claim 4 further including a positioning frame on one surface of the column for receiving the J-nut.

7. The mounting arrangement of claim 1 wherein the arms are integrally molded with the supporting structure.

8. The mounting arrangement of claim 1 wherein the arms are separate from the supporting structure and are coupled thereto by fasteners.

9. The mounting arrangement of claim 1 wherein the supporting structure is an automotive headlamp housing.

10. A mounting arrangement for mounting an automotive headlamp housing on an automotive structure, the mounting arrangement comprising:
an array of unitary beams joined to the automotive headlamp housing wherein each beam comprises:
a column portion having a coupling component thereon for attaching the unitary beam to the automotive vehicle, and a fork-shaped portion having a base extending in opposite directions of and transversely with respect to the column portion, the forked portion 10 including at least a pair of arms unitary with the base and extending transversely with respect to both the base and the column portion, the arms having ends joined to the headlamp housing.

11. The mounting arrangement of claim 10 wherein the array of unitary beams includes four unitary beams with a pair of unitary beams joined to opposite sides of the housing.

12. The mounting arrangement of claim 10 wherein the beams are tuned beams that are tuned to provide a minimum natural frequency in the range of about 30 to 60 Hz.

13. The mounting arrangement of claim 12 wherein the minimum natural frequency is about 45 Hz.

14. The mounting arrangement of claim 11 wherein the headlamp housing is mounted by the pairs of unitary beams to proximate portions of a bumper which comprises the automotive structure.

15. The mounting arrangement of claim 14 wherein the unitary beams each have a locating pin projecting from the front surfaces of the column portion for engagement with the bumper portion and wherein the coupling between the column and the bumper portion is a screw passing through a hole in the bumper portion.

16. The mounting arrangement of claim 10 wherein the automotive headlamp housing and unitary beams are made of a polymer material.

17. The mounting arrangement of claim 16 wherein the polymer material is polypropylene filled 30% with talc reinforcement.

18. The mounting arrangement of claim 17 wherein the unitary beams are unitary with the automotive headlamp housing.

19. The mounting arrangement of claim 10 wherein the unitary beams are separate from the automotive headlamp housing and are attached thereto by fasteners.
